(19) United States
(12) Patent Application Publication
(10) Pub. No.: US 2025/0238736 A1
(43) Pub. Date: Jul. 24, 2025

(54) PARTITIONED TASK MANAGEMENT SERVICE FUNCTIONALITY

(71) Applicant: Dealerware, LLC., Austin, TX (US)

(72) Inventors: Diana M. Castles, Austin, TX (US); Melissa Edwards, Austin, TX (US); Drew Dennis, Austin, TX (US)

(21) Appl. No.: 19/028,405

(22) Filed: Jan. 17, 2025

Related U.S. Application Data
(60) Provisional application No. 63/622,904, filed on Jan. 19, 2024.

(51) Int. Cl. G06Q 10/0631

(52) U.S. Cl. CPC G06Q 10/063114

(57) ABSTRACT

This disclosure provides systems, methods, and apparatuses, including computer programs encoded on computer storage media, for implementing a task management service by a first device. In one aspect of the disclosure, a method includes generating, based on a task request indicating a task to be performed, a task record and a task form. The method further includes sending the task form via a second computing device to a third computing device. The task form is configurable to be displayed on a graphical user interface (GUI) of the third computing device. The method also includes receiving, via the task form, one or more task parameters, and populating the task record based on the one or more task parameters. Other aspects and features are also claimed and described.

### CROSS-REFERENCE TO RELATED APPLICATIONS

This application claims priority to and the benefit of U.S. Provisional Application No. 63/622,904, filed Jan. 19, 2024, the contents of which is incorporated into the present application by reference.

### TECHNICAL FIELD

Aspects of the present disclosure relate generally to implementing a partitioned task management service functionality and more particularly, but not by way of limitation, to systems and methods for implementing the partitioned task management service functionality at a computing device. Some features may enable and provide for partitioning task related data and task related data processing from other types of data and other types of data processing to provide enhanced data processing efficiency, reduced energy usage, enhanced data security, and enhanced data sharing among a plurality of devices.

### BACKGROUND

Businesses often possess large quantities of data about their inventory, customers, and personnel. Computing systems that store this data typically perform critical functions for the business based on processing the data, such as accounting for inventory, making payroll, contacting customers for service appointments, and contacting customers as part of advertising campaigns. Additionally, businesses have discovered that leveraging their vast quantities of data by adding new functionalities to their computing systems to process the data in new and unconventional ways to facilitate the provision of new services or products is financially advantageous.

While adding new functionality to these computer systems to optimally leverage the stored data may be desirable, it is also difficult due, at least in part, to the large volume of data available. For example, adding new functionality to process the vast quantity of data in a new or different way may necessitate adding computational resources, such as additional processing power, more memory, or both. For instance, processing data in a new way to provide a new service may generate more data, necessitating additional data storage. Moreover, adding new functionality may consume more energy due to the additional data processing and data storage involved. Consuming more energy over a plurality of devices may increase costs and accelerate environmental damage. Further, some of this data may be confidential, proprietary, or sensitive, such that improper use or disclosure of the data may detrimentally affect the business, subjecting the business to potential financial and reputational harm. Adding new functionality may increase the risk of potentially inadvertent or nefarious disclosure or use of such data due, at least in part, to a larger quantity of accesses to the data.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method, performed by a first computing device, for implementing a partitioned task management service. The method includes receiving a task request. The task request indicates a task to be performed. The method also includes generating a task record based on the task request, and generating a task form based on the task request. The method further includes sending the task form via a second computing device to a third computing device. The task form is configurable to be displayed on a graphical user interface (GUI) of the third computing device. The third computing is distinct from the first computing device and distinct from the second computing device. The method includes receiving, via the task form, one or more task parameters, and populating the task record based on the one or more task parameters.

Another innovative aspect of the subject matter described in this disclosure can be implemented in an electronic device. The electronic device includes at least one processor and a memory coupled with the at least one processor. The memory storing processor-readable instructions that, when executed by the at least one processor, is configured to receive a task request. The task request indicates a task to be performed. The processor-readable instructions, when executed by the at least one processor, is also configured to generate a task record based on the task request, and generate a task form based on the task request. The processor-readable instructions, when executed by the at least one processor, is further configured to send the task form via a second computing device to a third computing device. The task form is configurable to be displayed on a GUI of the third computing device. The third computing is distinct from the first computing device and distinct from the second computing device. The processor-readable instructions, when executed by the at least one processor, is configured to receive, via the task form, one or more task parameters, and populate the task record based on the one or more task parameters.

Another innovative aspect of the subject matter described in this disclosure can be implemented in a non-transitory computer-readable medium storing instructions. The instructions, when executed by a processor, cause the processor to perform operations including receiving a task request. The task request indicates a task to be performed. The operations also include generating a task record based on the task request, and generating a task form based on the task request. The operations further include sending the task form via a second computing device to a third computing device. The task form is configurable to be displayed on a graphical user interface (GUI) of the third computing device. The third computing is distinct from the first computing device and distinct from the second computing device. The operations include receiving, via the task form, one or more task parameters, and populating the task record based on the one or more task parameters.

Some details associated with the implementations are described above, and others are described below. Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

A further understanding of the nature and advantages of the present disclosure may be realized by reference to the following drawings. The following drawings illustrate by way of example and not limitation. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram of an example partitioned task management system according to one or more aspects.

FIG. 2 is a block diagram of example data structures, data types, or combinations thereof to facilitate provision of a partitioned task management service according to one or more aspects.

FIG. 3 is an example data structure configured to facilitate provision of a partitioned task management service according to one or more aspects.

FIG. 4 illustrates an example task form to facilitate provision of a partitioned task management service according to one or more aspects.

FIG. 5 illustrates an example task form to facilitate provision of a partitioned task management service according to one or more aspects.

FIG. 6 is a ladder diagram depicting an example process to facilitate provision of a partitioned task management service according to one or more aspects.

FIG. 7 is a ladder diagram depicting an example process to facilitate provision of a partitioned task management service according to one or more aspects.

FIG. 8 is a flow diagram illustrating an example process that supports provision of a partitioned task management service according to one or more aspects.

FIG. 9-13 are diagrams illustrating example graphical user interfaces (GUIs) to facilitate provision of a partitioned task management service according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media for implementing a task management service as an additional service to complement one or more services. For example, the present disclosure describes a data model and algorithm to partition task related data and task related data processing from other types of data and other types of data processing. To illustrate, a first computing device, such as a task management platform, may receive a task request, indicating a task to be performed. The task request may be provided to the first computing device by a second computing device, such as an item tracking platform. The item tracking platform may perform one or more services, such as maintaining accounts of items. For instance, the items may be items of inventory. The second computing device may receive the task request from a third computing device that may correspond to a user-interfacing computing device.

The first computing device may generate a task record based on the task request. For example, the task record may be stored in a memory of the first computing device and may store task-related data associated with initiating a task management service functionality. The first computing device may generate a task form based on the task request. For instance, the task form may include or correspond to a webpage that includes one or more fillable fields. The first computing device may send the task form, via the second computing device, to the third computing device, which may display the task form on a graphical user interface (GUI) rendered on a display of the third computing device. In response to completion of the fillable fields of the task form, the first computing device may receive one or more task parameters. These task parameters may include a task description corresponding to the task, object identification data corresponding to an object on which a task is to be performed, geolocation data indicative of a location at which the task is to be performed, a first value indicating a requested initiation timeframe to initiate performance of the task, a second value indicating a requested completion timeframe to complete performance of the task, an identity of a customer for whom the task is to be performed, or a combination thereof. The first computing device may populate the task record based on the one or more task parameters. Additionally, based on the task record, the first computing device may provide, via the second computing device to a fourth computing device, a task instruction, viewable on a GUI of the fourth computing device and indicating task related data associated with the task to be performed. The task instruction may indicate a schedule for performance of the task, identities of employees or contractors to whom the task is assigned for completion, customer data associated with performance of the task, or a combination thereof.

As an illustrative example of the present disclosure, an employee or contractor of a vehicle dealership may initiate a task request on a computing device. The task request may indicate a task to be performed, such as an instruction to deliver a loaner vehicle to a customer of the dealership while the customer's vehicle is being repaired. Delivery of a loaner vehicle to the customer may be referred to as a “valet task.” The computing device may send the task request, via a network, to an item tracking platform, such as a server. The item tracking platform may include generalized data and generalized functionality to facilitate one or more operations, services, or both associated with the vehicle dealership. For instance, the item tracking platform may store data, such as vehicle identification numbers (VINs) associated with loaner vehicles operated by the dealership and available for use by certain of the dealership's customers. Additionally, the item tracking platform may store customer data about the dealership's customers, such as driver's license information; personnel data about employees and contractors of the dealership, such as identities of employees and personnel who are authorized to operate loaner vehicles; or combinations thereof.

The item tracking platform may send the task request to a task management platform, which may include or correspond to a server. The task management platform may generate a task record based on the task request. For example, the task record may correspond to a the task of delivering a loaner vehicle to a customer of the dealership while the customer's vehicle is being repaired. The task record may include a unique task identifier associated with the task of delivering a loaner vehicle to a customer of the dealership to distinguish that task from other tasks. Further, the task record may include a task type or task class associated with the task ID number, such as a task type of “valet,” which may distinguish the task from other task categories, such as maintenance tasks (e.g., tasks associated with maintaining a loaner vehicle). The task management platform may generate a task form based on the task request. The task form may include one or more fillable fields, tailored to the task type, such as the valet task type, which may be different from the one or more fillable fields associated with another task type such as a maintenance task type. For example, a first field of the task form based on the valet task type may request information about the customer for whom the valet task is to be performed, such as a name of the customer or other identifier of the customer, while a first field of the task form based on the maintenance type task may request a VIN number of a vehicle on which am maintenance task is to be performed.

The task management platform may send the task form via the item tracking platform to a computing device associated with a contractor or employee of the vehicle dealership. The task form may be rendered on the computing device, and the employee or contractor may complete the one or more fillable fields with the requested information, such as the preferred start date and start time for initiation of the valet task, a preferred completion date and time for completion of the valet task, a customer identifier indicating an identity of the customer for whom a loaner car is to be made available, or combinations thereof. The task management platform may receive, via the task form, the task parameters indicated in the completed one or more fillable fields, such as the preferred start date and start time for initiation of the valet task, the preferred completion date and time for completion of the valet task, and the customer identifier associated with a customer for whom the valet task is to be performed. The task management platform may populate the task record, stored in a task management database of the task management platform, based on the one or more task parameters included in the task form, such as based on the preferred start date and start time for initiation of the valet task, the preferred completion date and time for completion of the valet task, and the customer identifier associated with a customer for whom the valet task is to be performed.

To illustrate, in response to receipt of information about the preferred start date and start time for initiation of the valet task, the preferred completion date and completion time for completion of the valet task, and the customer identifier, the task management platform may link to one or more databases of the second computing device to obtain data with which to populate the task record. This data may include work schedules of employees or contractors authorized to perform valet tasks on behalf of the vehicle dealership. For instance, the task management platform may correlate work schedule data of authorized employees, authorized contractors, or both with the preferred task initiation date and time and the preferred task completion date and time to identify one or more employees or contractors of the vehicle dealership who may be available to perform the valet task. As another example, the data may include customer data relevant to performing the valet task, such as an access code of the customer (e.g., a gate code, a house code) so that access may be obtained to facilitate delivery of the loaner vehicle to the customer. As a further example, the data may include vehicle information, such as VINs of loaner vehicles. The task management platform may identify that a customer associated with a customer identifier prefers certain types of vehicles based on customer data stored in one or more databases of the item tracking platform. Based on correlating data about available loaner vehicles, requested task initiation and completion times and dates, employees and contractors authorized to perform the valet task during the preferred initiation and completion timeframes, and customer preference information, the task management platform may populate the task record with VINs of vehicles optimally suited for the valet task in accordance with execution of the correlation operations.

Based on the populated task record, the task management platform may generate a task instruction. The task instruction may include task data associated with the task, such as scheduling information corresponding to the valet task, an identity of an authorized employee or authorized contractor of the vehicle dealership assigned to perform the valet task, customer data relevant to performing the valet task, such as the customer gate code, and a VIN number of a suitable loaner vehicle. The task management platform may provide the task instruction, via the item tracking platform, to a computing device associated with an authorized employee or authorized contractor of the vehicle dealership, identified, in the task record, as being available to perform the valet task according to the task scheduling data. The computing device may render the task instruction on a display of the computing device so that the task instruction is viewable by the authorized employee or contractor of the vehicle dealership, who may execute the task in accordance with the task instruction. Additionally or alternatively, the task instruction may automatically updated one or more fields of the fillable form rendered on the computing device to include information identified in the task instruction.

Particular implementations of the subject matter described in this disclosure can be implemented to realize one or more of the following potential advantages. In some aspects, the present disclosure enables and provides enhanced functionality by facilitating provision of a partitioned task management service while improving overall system computational efficiency. To elaborate, by storing task related data and performing task related data processing on a first computing device, such as a task management platform, that is partitioned from a more generalized second computing device, such as an item tracking platform, the additional functionality of a task management service may be provided without reducing the computational efficiency of the generalized item tracking platform. For example, the task management platform may be configured to make one call to a memory of the item tracking platform to populate the task record with task related data to construct a task instruction. Subsequently, calls may be made to a memory of the task management platform rather than to the memory of the item tracking platform to facilitate provision of the task management service. By minimizing calls to the memory of the item tracking platform, enhanced computational efficiency may be provided while also providing the enhanced functionality of the partitioned task management service.

A further advantage of partitioned task management may include reduced energy usage. As above, by enhancing a computational efficiency with which a task management functionality may be performed, less energy may be expended in performing the task management functionality than in a system in which task management data and processing is not partitioned. Over millions of executed task management related data processing functions, significant energy savings may be realized, thereby reducing overall electricity usage by a system executing the partitioned task management functionality.

An additional advantage of partitioned task management may include enhanced intra-device compatibility. Each task request may have different data formats, different data types, or combinations thereof depending on the computing system that generated task request, depending on a user of the computing system, or a combination thereof. In contrast, since each task instruction is generated by the task management platform based on the task record, the task instruction may have uniform data encoding, uniform data formatting, uniform data types, or combinations thereof even though each task request may not. Accordingly, the task instruction may be parsed by any computing device, even though receiving computing devices, such as the second computing device and third computing device, may each may different from one another. In this manner, a compatibility among devices of a system executing a partitioned task management functionality may be enhanced.

Another advantage of partitioned task management may include enhanced data security. By storing task related data in the first computing device and by performing task related data processing on the first computing device, fewer calls are made to the much larger quantity of data stored in a memory of the second computing device. Since the second computing device may store terabytes of potentially sensitive data about customers, reducing the number of calls to a memory of the second computing device may reduce potential exposure of the data to malevolent access by unauthorized third parties.

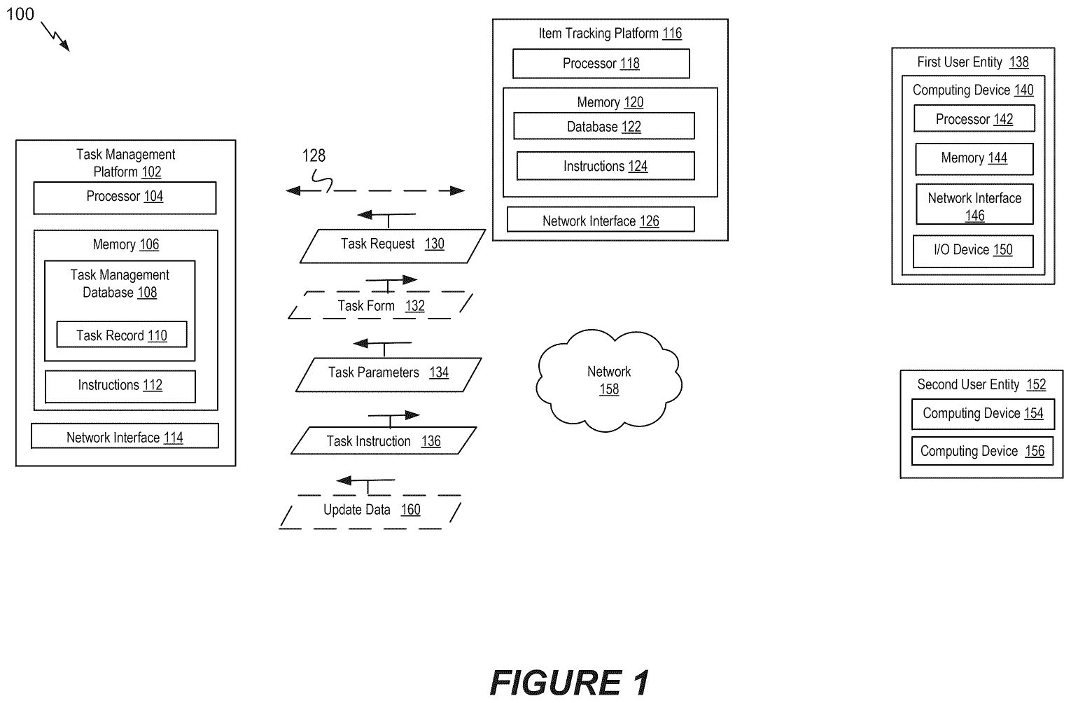

Referring to FIG. 1, a block diagram of an example partitioned task management system 100 according to one or more aspects is depicted. System 100 includes task management platform 102, item tracking platform 116, first user entity 138, and second user entity 152. Task management platform 102, item tracking platform 116, or both may include or correspond to server computers. First user entity 138 may include or correspond to a first vehicle dealership, and second user entity 152 may include or correspond to a second vehicle dealership distinct from the first vehicle dealership.

First user entity 138 includes or is associated with computing device 140, and second user entity 152 includes or is associated with computing devices 154,156. Although first user entity 138 is depicted as being associated with computing device 140, first user entity 138 may be associated with a plurality of computing devices. Further, although second user entity 152 is depicted as being associated with computing devices 154, 156, second user entity 152 may be associated with one computing device or with a plurality of computing devices.

Task management platform 102 includes a processing system, the processing system including one or more processors (collectively referred to as “processor 104”), one or more memories (collectively referred to as “memory 106”), or a combination thereof. Additionally, task management platform 102 includes network interface 114. Although not depicted, task management platform 102 may include one or more input/output (I/O) devices, such as a mouse, keyboard, monitor, other interface, or a combination thereof configured to receive inputs from a user, to provide outputs to the user, or both. Different server and computer architectures can be utilized to implement task management platform 102, and task management platform 102 is not limited to a particular architecture provided that the hardware implementing task management platform 102 supports the functions of the management system disclosed herein.

Processor 104 may include a central processing unit (CPU) or microprocessor, a graphics processing unit (“GPU”), microcontroller, or a combination thereof that has been programmed to perform the functions of task management platform 102. Implementations described herein are not restricted by the architecture of processor 104 provided that processor 104, whether directly or indirectly, supports the operations described herein. Processor 104 may be one component or multiple components that may execute the various described logical instructions, such as instructions 112. The present disclosure is not restricted by the architecture of processor 104, provided that processor 104 supports modules, configurations, or operations as described herein. Further, as will be understood by those of skill in the art, a “module” can include an application-specific integrated circuit (“ASIC”), an electronic circuit, a processor (shared, dedicated, or group) that executes one or more of software or firmware, a combinational logic circuit, and/or other suitable components that provide the described functionality. In some implementations, a module is “[a] self-contained hardware or software component that interacts with a larger system.” Alan Freedman, “The Computer Glossary” 268 (8th ed. 1998).

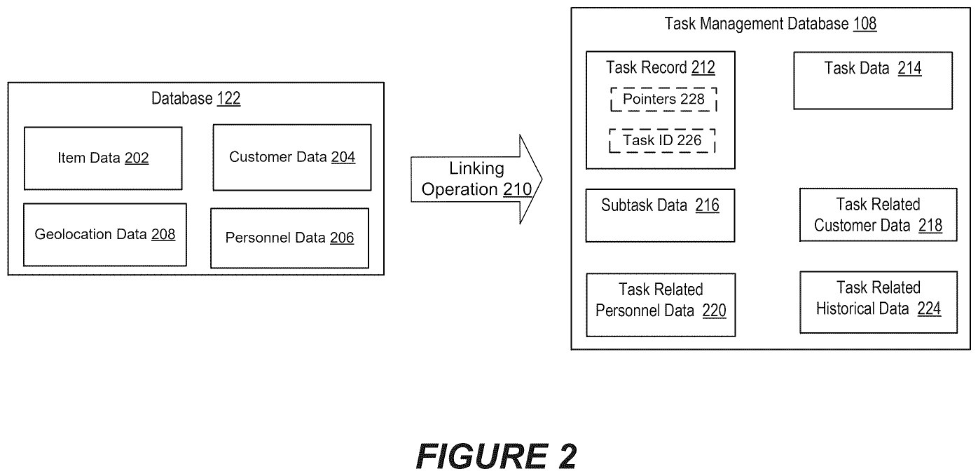

Memory 106 includes or is configured to store task management database 108 and instructions 112. Task management database 108 may include task-related data as explained more fully with reference to FIG. 2. Additionally, task management database 108 may store task record 110. Task record 110 may include or store specific task related data to implement the task management functionality described herein. For example, task record 110 may include a task identifier (ID) indicating a task type to be performed, such as a valet task type, a maintenance task type, or the like. Additionally, task record 110 may be configured to store data related to the task ID. For instance, for a task ID that corresponds to a valet task, task record 110 may be configured to store data related to performance and execution of the valet task. Instructions 112 may include or correspond to object code, source code, firmware, or combinations thereof that, when executed by processor 104, cause processor 104 to perform operations according to aspects of the present disclosure, as described herein.

Network interface 114 may be adapted to couple task management platform 102 to a network, which can be one or more of a LAN, WAN, and/or the Internet, such as network 158. Therefore, in some implementations, task management platform 102 may be accessed via an online portal. In some implementations, network interface 114 includes a transceiver configured to send and receive signals, such as electronic signals. Although described as a transceiver, network interface 114 may alternatively include a receiver, a transmitter, or both. In some implementations, network interface 114 includes a wireless interface such as a LoRa interface, a Wi-Fi interface (e.g., an IEEE 802.11 interface), a cellular interface, a Bluetooth interface, a BLE interface, a Zigbee interface, another type of low power network interface, or the like.

Item tracking platform 116 includes a processing system, the processing system including one or more processors (collectively referred to as “processor 118”), one or more memories (collectively referred to as “memory 120”), or a combination thereof. Additionally, item tracking platform 116 includes network interface 126. Although not depicted, item tracking platform 116 may include one or more input/output (I/O) devices, such as a mouse, keyboard, monitor, other interface, or a combination thereof configured to receive inputs from a user and to provide outputs to the user. Different server and computer architectures can be utilized to implement item tracking platform 116, and item tracking platform 116 is not limited to a particular architecture provided that the hardware implementing item management platform 116 supports the functions of the management system disclosed herein.

Processor 118, memory 120, and network interface 126 may correspond to (e.g., be analogous to) processor 104, memory 106, and network interface 114. Accordingly, processor 118, memory 120, and network interface 126 may include similar features to those described with reference to processor 104, memory 106, and network interface 114. Memory 120 may be configured to store databased 122 and instructions 124. Database 122 may include or correspond to data associated with operations of first user entity 138, second user entity 152, or both. For example, database 122 may store customer data associated with or corresponding to customers of first user entity 138, second user entity 152, or both, employee or contractor data associated with or corresponding to employees or contractors of first user entity 138, second user entity 152, or both, or combinations thereof. Instructions 124 may include or correspond to object code, source code, firmware, or combinations thereof that, when executed by processor 118, cause processor 118 to perform operations according to aspects of the present disclosure, as described herein.

Computing device 140 includes a processing system, the processing system including one or more processors (collectively referred to as “processor 142”), one or more memories (collectively referred to as “memory 144”), or a combination thereof. Additionally, computing device 140 includes network interface 146 and I/O device 150.

Processor 142. memory 144, and network interface 146 may correspond to (e.g., may be analogous to) processor 104, memory 106, and network interface 114. Accordingly, processor 142, memory 144, and network interface 146 may include similar features to those described with reference to processor 104, memory 106, and network interface 114.

I/O device 150 may couple computing device 140 to one or more data storage devices, such as one or more of a hard drive, a solid state storage device, a flash drive, a compact disc (CD) drive, a floppy disk drive, a tape drive, and/or the like. Also, the one or more data storage devices can be a separate server coupled to computing device 140 through a network connection to I/O device 150. I/O device 150 may include a display configurable to be driven by processor 142 to control presentation via a display device (not depicted). In some implementations, I/O device 150 may display a graphical user interface (GUI) associated with a software or web-based application on a display device, such as a monitor or touch screen. Additionally, I/O device 150 may include or correspond to a keyboard, a pointing device, and/or a touch screen of computing device 140. I/O device 150 may be configured to receive inputs from a user and may further be configured to provide outputs to a user. Computing devices 154, 156 may be similar to computing device 140 and may thus include similar components as described above with respect to computing device 140.

The concepts described herein are not limited to the architecture of task management platform 102, item tracking platform 116, computing devices 140, 154, 156, or any combination thereof. Rather, the foregoing are provided as examples of one type of computing device that can be adapted to perform the functions of the devices as described herein. In particular, any suitable processor-based device can be utilized including, without limitation, personal data assistants (PDAs), computers, laptops, tablet computers, smartphones, computer game consoles, multi-processor servers, and the like, as illustrative, non-limiting examples.

For example, while task management platform 102 and item tracking platform 116 are illustrated as physically distinct systems, in some implementations, task management platform 102 and tracking platform 116 may be implemented on a single system that includes processor 104, processor 118, memory 106, memory 120, network interface 114, and network interface 126. Additionally or alternatively, a functionality of task management platform 102 may be partitioned from a functionality of item tracking platform 116 virtually through a software implementation. For example, processor 118 of item tracking platform 116 executing instructions 124 may be configured to partition memory 120 to allocate particular addresses to task management database 108. Additionally, processor 118 may be configured to perform task management functionality in parallel with the overall functionality of item tracking platform 116 or serially at particular timeframes.

Moreover, the systems and methods of the present disclosure can be implemented on application specific integrated circuits (ASIC), very large scale integrated (VLSI) circuits, or other circuitry. Additionally, it should be appreciated that the devices described herein, or certain components thereof, may reside at, or be installed in, different locations within system 100. In some implementations, the devices of system 100 includes one or more servers or a cloud-based computing platform configured to perform operations or execute the steps described herein. Accordingly, any of the devices of system 100 may include a particular purpose computing system designed, configured, or adapted to perform and/or initiate operations, functions, processes, and/or methods described herein and can be communicatively coupled with a number of end user devices, which can be, e.g., a computer, tablet, smartphone, or other similar end user computing device, as illustrative, non-limiting examples. Users can interact with any of the devices of system 100 using a device via one or more networks, such as network 158, which itself can include one or more of a local intranet, a LAN (Local Area Network), a WAN (Wide Area Network), a virtual private network (VPN), and the like. Communicative coupling between different devices of system 100 can be provided by, e.g., one or more of wireless connections, a synchronous optical network (SONET) connection, a digital Tl, TN, El or E3 line, Digital Data Service (DDS) connection, DSL (Digital Subscriber Line) connection, an Ethernet connection, and the like, as illustrative, non-limiting examples.

Network 158, such as a communication network, may facilitate communication of data among components of system 100. For example, network 158 may facilitate communication of data among task management platform 102, item tracking platform 116, computing device 140, computing device 154, and computing device 156. Network 158 may include a wired network, a wireless network, or a combination thereof. For example, network 158 may include any type of communications network, such as a direct PC-to-PC connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate.

During a typical cycle of operation of system 100, task management platform 102 may receive task request 130 from computing device 140, 154, 156 or any combination thereof via item tracking platform 116. For example, item tracking platform 116 may receive task request 130 generated at one of computing device 140, 154, or 156 via network 158 and may send task request 130 to task management platform 102 via secure channel 128 established between task management platform 102 and item tracking platform 116. Secure channel 128 may include more robust encryption than may be otherwise applied to transmit data over network 158. Alternatively, item tracking platform 116 may send task request 130 received, by item tracking platform 116, from computing device 140, 154, 156, or any combination thereof to task management platform 102 via network 158.

Task request 130 may indicate a task to be performed, such as a valet task or a maintenance task. For instance, task request 130 may include a unique task ID associated with a task type, such as a unique task identifier associated with a valet task, a maintenance task, or other types of tasks. Alternatively, task request 130 may include or correspond to an electronic mail message, a text message, or any combination thereof that includes a textual description of a task to be performed.

In general, task request 130 may be provided in multiple different formats, possibly depending on the computing device, such as computing device 140, 154, 156, on which task request 130 is generated. For example, computing device 140 may be a computing functionality incorporated into a vehicle of first user entity 138. Computing device 140 may generate task request 130 in a first format, such as specified by an instruction set architecture (ISA) of the computing device 140. In contrast, computing device 154 may be a smartphone associated with an employee of second user entity 152. Computing device 154 may generate task request 130 having a second format that is different from the first format.

Task management platform 102 may generate task record 110 based on the task request 130 and may store task record 110 in memory 106, such as in task management database 108. Task record 110 may include a unique task ID associated with or corresponding to the task type generated based on data included with the task request 130. For instance, in response to task request 130 including a textual description of the task, processor 104, parsing task request 130, may associate a unique task ID with the task type corresponding to the textual description of the task. As explained in more detail below, task management platform 102 may populate task record 110 to include data associated with performance of the task. For example, task record 110 may include an employee or contractor identifier to indicate an identity of an employee or a contractor of first user entity 138 or second user entity 152, who is authorized and available to perform the task on behalf of first user entity 138 or second user entity 152. Additionally, task record 110 may include task-related customer data associated with a customer for whom a task is to be performed. Such task-related customer data may include a gate code to facilitate access to a property of a customer at which the task is to be performed.

Additionally, task management platform 102 may generate task form 132 based on task request 130. Task form 132 may include or correspond to a webpage that includes one or more fields or entries to be completed, such as by a user of computing device 140, 154, or 156. The types of additional information requested via task form 132 may depend on the data included with task request 130, the task type of the task corresponding to task request 130, or both. For instance, if not included in task request 130, task form 132 may request identification, by a user of computing device 140, 154, or 156, of a requested task initiation date, a requested task initiation time, a requested task completion date, a requested task completion time, or both. Additionally or alternatively, if task management platform 102 identifies the task request 130 as being associated with a valet task type, task form 132 may include an entry or field requesting an identity of the customer to whom a loaner car may be delivered, assuming that the information was not included in task request 130.

Task management platform 102 may send task form 132 to a computing device, such as a computing device that originated task request 130, which may correspond to any one of computing devices 140, 154, or 156. In some implementations, task management platform 102 may send task form 132 to computing device 140, 152, 156 via item tracking platform 116. In other implementations, task management platform 102 may send task form 132 to computing device 140, 152, 156 directly via network 158. Task form 132 may be configurable to be displayed on a GUI of computing device 140, 152, 156 rendered on I/O device 150.

Task management platform 102 may receive, via task form 132 completed by computing device 140, 154, 156 or by a user of computing device 140, 154, 156, one or more task parameters 134. These task parameters 134 may include a task description corresponding to the task, object identification data corresponding to an object on which a task is to be performed, geolocation data indicative of a location at which the task is to be performed, or a combination thereof. Additionally, task parameters 134 may include a first value indicating a requested initiation timeframe to initiate performance of the task, a second value indicating a requested completion timeframe to complete performance of the task, a customer identifier (e.g., a customer name or other unique identifying information) corresponding to a customer for whom the task is to be performed, or a combination thereof.

Task management platform 102 may populate task record 110 based on one or more task parameters 134. To elaborate, task management platform 102 may link to database 122 stored in memory 120 of item tracking platform 116 and may extract portions of data from database 122, the portions of data associated with one or more task parameters 134. For example, a task parameter of one or more task parameters 134 may include or correspond to a customer identifier. Based on the task type and the customer identifier included in one or more task parameters 134, task management platform 102 may retrieve task-related customer data from database 122. The task-related customer data associated with a valet task may include a customer access code (e.g., a gate code) to be used to access a customer's property for the purpose of delivering a loaner vehicle to the customer. As another example, based on a requested initiation timeframe to initiate performance of the task and a requested completion timeframe to complete performance of the task included in task parameters 134 and for a valet task type, task management platform 102 may obtain VINs from database 122, the VINs associated with loaner vehicles available for loan during the timeframe covered by the requested task initiation and task completion timeframes.

In extracting data from database 122 of item tracking platform 116 to populate task record 110, task management platform 102 may apply machine learning techniques to identify portions of data from database 122 relevant to the task, perhaps using historically collected task related data stored in task management database 108 to identify patterns in data useful for task management. For example, task management platform 102 may correlate a task type, such as a valet task type, with data from database 122 associated with the task type, such as VINs, customer access codes, or combinations thereof. Additionally or alternatively, in populating task record 110, task management platform 102 may correlate data extracted from database 122 with one or more task parameters 134, with task request 130, with data obtained from task form 132, or combinations thereof. For instance, based on customer data extracted from database 122, such as customer data indicating a customer preference for certain types of vehicles, in response to identifying a task type as a valet task type based on task request 130, and in response to receiving, as a task parameter of one or more task parameters 134 a requested task initiation timeframe and a request task completion timeframe, task management platform 102 may extract VINs from database 122 that match the customer preferences included in extracted customer data in addition to VINs associated with vehicles that are available for use between the task initiation timeframe and task completion timeframe.

Task management platform may generate task instruction 136 based on task record 110. Task instruction 136 may include information to facilitate performance of a task corresponding to task request 130. For example, task instruction 136 may identify an employee or contractor of first user entity 151 or second user entity 152 who is qualified to perform the task and who is available to do so. Additionally, task instruction 136 may include customer data to facilitate performance of the task associated with task request 130, such as customer access data, such as codes to access a customer's home, car, or both. Further task instruction 136 may include scheduling information, identifying an initiation date and time for performance of the task and a completion date and time for performance of the task, which, in some cases, may differ from the requested initiation date and time and requested completion date and time included in one or more task parameters 134.

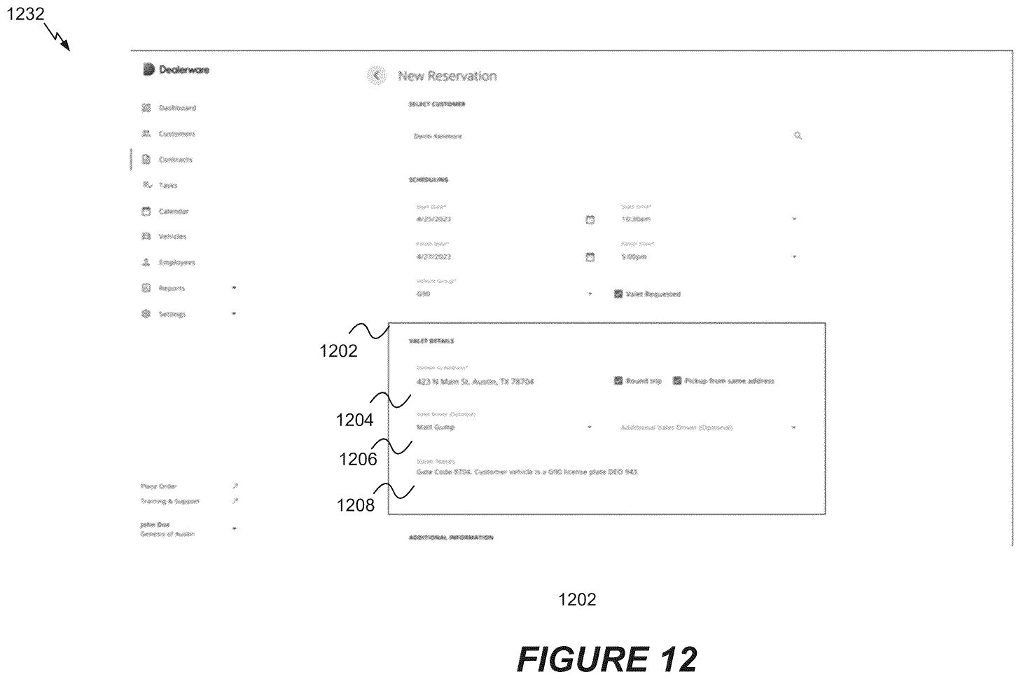

Task instruction 136 may include or correspond to a webpage, text message, instant message, electronic mail, or any of the foregoing configurable to be rendered on a display device, such as corresponding to I/O device 150, or configurable to be parsed by a computing device. Additionally or alternatively, task instruction 136 may include or correspond to code that, when executed by a computing device, updates fields of task form 132 as explained more fully with reference to FIG. 12 below, causes the computing devices to perform functionality as specified in the code, or a combination thereof. Task management platform 102 may send task instruction to one or more computing devices, such as computing devices 140, 154, or 156 associated with the employee or contractor identified in task instruction 136 as being assigned to the task. For example, task management platform 102 may send task instruction 136 to computing devices 140, 154, or 156 via item tracking platform 116. However, in some implementations, task management platform 102 may send task instruction 136 directly to computing device 140, 154, or 156 via network 158 without sending task instruction 136 to item tracking platform 116.

It is noted that operations of system 100 are not limited to the above description. For example, in some implementations, task management platform 102 may receive task request 130 directly from computing device 140, 154, 156, or any combination thereof via network 158, rather than via item tracking platform 116. In other implementations, task management platform 102 may not generate task form 132, task request 130 may be generated by item tracking platform 116 rather than by computing devices 140, 154, 156, or any combination thereof.

For example, in some implementations, task request 130 may include task parameters 134 thereby obviating generation and transmission of task form 132. To illustrate, computing device 140 may be associated with or positioned in a vehicle of first user entity 138. In response to receipt, by computing device 140, of an indication from one or more sensors of the vehicle that maintenance may be necessary (e.g., a sensor indicating poor oil quality), computing device 140 of the vehicle may transmit data indicating possible maintenance needs to item tracking platform 116. Based on receipt of the data from computing device 140 of the vehicle, item tracking platform 116 may generate task request 130. Task request 130 may indicate task parameters 134, such as the VIN of the vehicle, a timeframe during which a maintenance task is to be initiated and completed, a location of the vehicle, or any combination thereof. In response to receipt of task request 130 that includes task parameters 134, task management platform 102 may generate task record 110. Based on task parameters 134 included in task request 130, task management platform 102 may populate task record 110 with the VIN; scheduling data for the maintenance task; an indication of a maintenance task type, such as whether the maintenance task corresponds to an oil change or other maintenance related task; or combinations thereof. Further, task management platform 102 may generate, based on task record 110, task instruction 136, readable by a receiving computing device, such as computing device 140, 154, or 156.

In some implementations, one or more computing devices receiving task instruction 136 may be a robot configured to perform tasks based on commands included in task instruction 136. Continuing with the example of a maintenance task as above, a computing device, such as computing device 140, 154, or 156, may be configured to read commands included in task instruction 136 and in which the command correspond to one or more instructions to perform actions corresponding to the maintenance task. For instance, computing device 154 may include or correspond to a computing device communicatively coupled to a vehicle and configured to obtain data from the vehicle in response to receipt, by the computing device, or task instruction. In response to receipt of task instruction 136, the computing device may send additional data, as identified in task instruction 136, to task management platform 102 via item tracking platform 116 and in which the additional data may be included, by task management platform, in task record 110.

Additionally, task management platform 102 may be configured to identify absence of data from populated task record 110. For instance, task management platform 102 may identify that an identity of personnel to effectuate the maintenance task would be advantageous to include in task record 110. Accordingly, task management platform 110 may link to database 122 of item tracking platform 116 to obtain identities of personnel of first user entity 138 who are authorized to perform the maintenance task and who are available during the timeframes specified in task request 130. Thus, task management platform 110 may populate task record 110 with such personnel data obtained from linking to database 122 of item tracking platform 116.

Based on populated task record 110, task management platform 102 may generate task instruction 136. Task instruction 136 may indicate a timeframe during which the maintenance task is to be initiated and completed, an identity of an employee or contractor of first user entity 138 to perform the maintenance task, and an indication of the maintenance task type, such as that the maintenance task is an oil change, a repair, or the like. In some implementations, task management platform 102 may send task instruction to item tracking platform 116, and item tracking platform 116 may send the instruction to a computing device associated with an employee or contractor of first user entity 138 identified in task instruction 136 to perform the maintenance task. Task instruction 136 may be configurable to be rendered on a display of the computing device and viewable by the employee or contractor associated with the computing device.

In some implementations, task instruction 136 may have a homogenized data format even though task request 130 may have a plurality of different data formats. For example, item tracking platform 116 and computing devices 140, 154, 156 may all be distinct systems and may thus encode data in different ways. Further, since a user of computing device 140 may include different types of information in task request 130 than a user of computing device 154, task request 130 generated by computing device 140 may be different from (i.e., include different data than) task request 130 generated by computing device 152. Accordingly, task requests 130 may include a plurality of different data formats, different types of data, or combinations thereof. In contrast, task management platform 102 may generate a homogenized task instruction 136 for each task request 130. In particular task instruction 136 may have a uniform data format encoded in a uniform manner, regardless of the encoding of task request 130. Thus, task instruction 136 may be parsed by any computing device.

In some implementations, task management platform may receive update data 160. Update data 160 may include or correspond to data indicating task progress, such as sub-tasks of a task that have been completed, an anticipated completion time and date associated with the task, or a combination thereof. To illustrate, as task is being performed, computing device 140, 154, or 156 may generate or receive (e.g., from a user of the computing device) indications of the subtasks of a task that have been completed, an expected completion time and completion date or the task, or a combination thereof. For example, an employee or contractor assigned to perform the task may provide indications, to a computing device associated with the employee or contractor, of subtasks of the task that have been completed, and the computing device may send corresponding update data 160 to task management platform 102 possible via item tracking platform 116. As another example, in scenarios in which the computing device, such as computing device 140, 154, or 156 automatically performs the task, computing device 140, 154, or 156 may generate and transmit update data 160 to task management platform 102 possibly via item tracking platform 116.

Partitioned task management as described with reference to FIG. 1 confers numerous advantages. One such advantage may include enhanced computational efficiency while providing the additional functionality associated with task management functions implemented by task management platform 102. To elaborate, by performing task related data processing and storage tasks in task management platform 102 rather than on item tracking platform 116, computational resources of item tracking platform 116 may be conserved. In this way, the additional functionality provided by task management platform 102 may be realized without reducing a computational efficiency of item tracking platform. For example, and as explained above, to populate task record 110, task management platform 102 may make one call to memory 120 of item tracking platform 116 to extract task related data from database 122. Thereafter, processing activities to generate task instruction 136 based on task record 110 (e.g., based on task related data associated with task record 110) may be performed entirely on task management platform 102. Hence, computational resources of item tracking platform 116 are not burdened to provide the task management functionality of task management platform 102.

As another example of enhanced computational efficiency, database 122 of item tracking platform 116 may store terabytes of data associated with a plurality of different user entities, such as first user entity 138 and second user entity 152. In a non-partitioned system, such as in a system in which item tracking platform 116 performs task management functionality, item tracking platform 116 may sift through terabytes of data to process data related to task management functions each time item tracking platform 116 executes a task management processing task. In contrast, by partitioning task management functionality, as described with respect to FIG. 1, task management platform 102 extracts relevant task related data from database 122 of item tracking platform 116 and stores the relevant task related data in task management database 108. Since a volume of relevant task related data stored in task management database 108 may be smaller than the volume of data stored in database 122 of item tracking platform 116, each call to task management database 108 by processor 104 to perform task related data processing tasks is more efficient (e.g., takes less time, less energy, or both) than a similar call by processor 118 to database 122. In this manner, task related data processing performed by task management platform 102 may occur with greater speed and overall efficiency than in a system in which task related data and processing is not partitioned.

A further advantage of partitioned task management may include reduced energy usage. As above, by enhancing a computational efficiency with which a task management functionality may be performed, less energy may be expended in performing the task management functionality than in a system in which task management data and processing is not partitioned. Over millions of executed task management related data processing functions, significant energy savings may be realized, thereby reducing overall electricity usage by a system, such as system 100.

An additional advantage of partitioned task management may include enhanced intra-device compatibility due to task instruction 136 homogenization. To elaborate and as above, each task request 130 may have different data formats, different data types, or combinations thereof depending on the computing system that generated task request 130, depending on a user of the computing system, or a combination thereof. In contrast, since each task instruction 136 is generated by task management platform 102 based on task record 110, task instruction 136 may have uniform data encoding, uniform data formatting, uniform data types, or combinations thereof even though each task request 130 may not. Accordingly, task instruction 136 may be parsed by any computing device, even though receiving computing devices, such as item tracking platform 116 and computing devices 140, 154, 156 may each may different from one another. In this manner, a compatibility among devices of system 100 may be enhanced.

Another advantage of partitioned task management may include enhanced data security. As above, by storing task related data in task management database 108 and by performing task related data processing on task management platform 102, fewer calls are made to the much larger quantity of data stored on database 122 of item tracking platform 116. Since database 122 may store terabytes of potentially sensitive data about customers of a plurality of user entities, such as first user entity 138 and second user entity 152, reducing the number of calls to database 122 of item tracking platform 116 reduces potential exposure of the data to malevolent access by unauthorized third parties. Additionally, as above, in some implementations, task request 130, task form 132, task parameters 134, and task instructions 136 are exchanged solely between task management platform 102 and item tracking platform 116 over secure channel 128. For example, in these implementations, task management platform 102 is not accessed directly by computing devices 140, 154, 156. In these implementations, by limiting significant task related data exchange to task management platform 102 and item tracking platform 116, fewer opportunities may be presented for third party nefarious access to data exchanged between task management platform 102 and item tracking platform 116. Accordingly, partitioned task management may provide enhanced data security.

Referring to FIG. 2, block diagram of example data structures, data types, or combinations thereof to facilitate provision of a partitioned task management service according to one or more aspects is depicted. Depicted in FIG. 2 are database 122 of item tracking platform 116 and task management database 108 of task management platform 102. As explained with reference to FIG. 1, in response to receipt of a task request, such as task request 130, task management platform 102 may establish task record 212 in task management database 108. Additionally, through one or more linking operations, such as linking operation 210, task record 212, task management database 108, or both may be populated. Additional details regarding establishment of task management database 108 are provided below.

As illustrated in FIG. 2, a database, such as database 122 of item tracking platform 116, may include a plurality of different data types. For example, database 122 may include item data 202, customer data 204, personnel data 206, geolocation data 208, or combinations thereof. Item data 202 may include or correspond to VINs associated with vehicles, a quick-response code (QR) code assigned to one or more items of product in inventory, bar codes associated with one or more items of product in inventory, or any combination thereof. Customer data 204 may include or correspond to information about or associated with customers, such as customers of first user entity 138, second user entity 152, or both. For instance, customer data 204 may include social security numbers (SSNs); first, middle, and last customer names; other identifiers assigned to customers; customer preference data; credit card numbers associated with customers; financial data associated with customers; or combinations thereof. Personnel data 206 may include or correspond to data associated with employees, contractors, or both, such as employees, contractors, or both of first user entity 138, second user entity 152, or both. For example, personnel data 206 may include SSNs of personnel; task descriptors of task categories that personnel are authorized to perform; personnel evaluation data; or combinations thereof. Geolocation data 208 may include or correspond to geolocation data indicating a location of one or more task sites at which one or more tasks are to be performed, indicating a location of an item on which a task is to be performed (e.g., a location of a vehicle that is to be serviced), or combinations thereof. It is understood that the foregoing data types are only examples and that other data types may be stored in database 122. Further, database 122 is likely to store large quantities of data, such as terabytes of data.

Task management database 108 may include task record 212, task data 214, subtask data 216, task related customer data 218, task related personnel data 220, task related historical data 224, or any combination thereof. Task record 212 may include or correspond to task record 110. Task data 214, subtask data 216, task related customer data 218, task related personnel data 220, task related historical data 224, or any combination thereof may include data extracted from database 122 through linking operation 210 executed by task management platform 102.

Task data 214 may include generalized data associated with a task, such as a task ID associated with the task, a contract ID indicating or pointing to an address of memory 120 at which a contract associated with a task may be stored, a location id indicating or pointing to an address of memory 120 at which geolocation data associated with the task may be stored, or an combination thereof.

Subtask data 216 may include or correspond to data associated with a subtask associated with a task. For example, subtask data 216 may include or correspond to data associated with a valet subtask, a maintenance subtask, or any combination thereof. To illustrate subtask data 216 may include or correspond to data associated with a valet subtask, such as an address to which a loaner vehicle is to be deposited, a distance from a present location of a loaner vehicle to an address to which the loaner vehicle is to be deposited, an initial quantity of fuel in the loaner vehicle when the loaner vehicle is deposited at the indicated address, a final quantity of fuel in the loaner vehicle when the loaner vehicle is returned, or combinations thereof.

Task related customer data 218 may include or correspond to data associated with customers for whom a task is to be performed. Task related customer data 218 may include a customer identifier associated with such a customer, preferences of such a customer, or the like.

Task related personnel data 220 may include or correspond to data associated with personnel assigned to perform as task. For example, task related personnel data 220 may include or correspond to an identifier associated with personnel assigned to perform a task, a location of personnel to perform the task, a schedule of personnel assigned to perform the task, or any combination thereof.

Task related historical data 224 may include or correspond to data collected over time regarding performance of tasks. For example, task related historical data 224 may include data corresponding to an actual amount of time expended to complete a task, actual labor costs incurred to perform the task, or combinations thereof. In some implementations and based on historical data 224, task management platform 102 may apply machine learning techniques, such as statistical analysis, to derive patterns in historical data 224 and may apply the derived patterns to generate task instructions 136. For example, in response to identifying, based on analysis of historical data 224, that a first employee is particularly efficient at perform a certain task type, such as a valet task, while a second employee is particularly inefficient at perform the same task type, task management platform 102 may be configured to bias assigning of valet task types in favor of the first employee. It is understood that historical data 224 may include terabytes of data to be analyzed, using machine learning techniques, within seconds, milliseconds, or nanoseconds.

Task record 212 may include task ID 226, pointers 228, or both. Upon receipt of task request 130, task management platform 102 may parse task request 130, thereby identifying, based on task request 130, a unique task ID 226 associated with a task type included in task request 130. For example, a valet task may be associated with ID 123, while a maintenance task may be associated with ID 723. Additionally, pointers 228 may include pointer variables containing addresses of memory 106 at which task data 214, subtask data 216, task related customer data 218, task related personnel data 220, task related historical data 224, or any combination thereof may be stored for rapid access to this data. Alternatively, task data 214, subtask data 216, task related customer data 218, task related personnel data 220, task related historical data 224, or any combination thereof may be stored in task record 212.

While FIG. 2 describes ways in which task related data may be stored in memory 106, these are only examples provided for illustrative purposes. It should be understood that data structures other than look-up tables may be used to store task related data. For instance, task related data may be stored in a graph data structure.

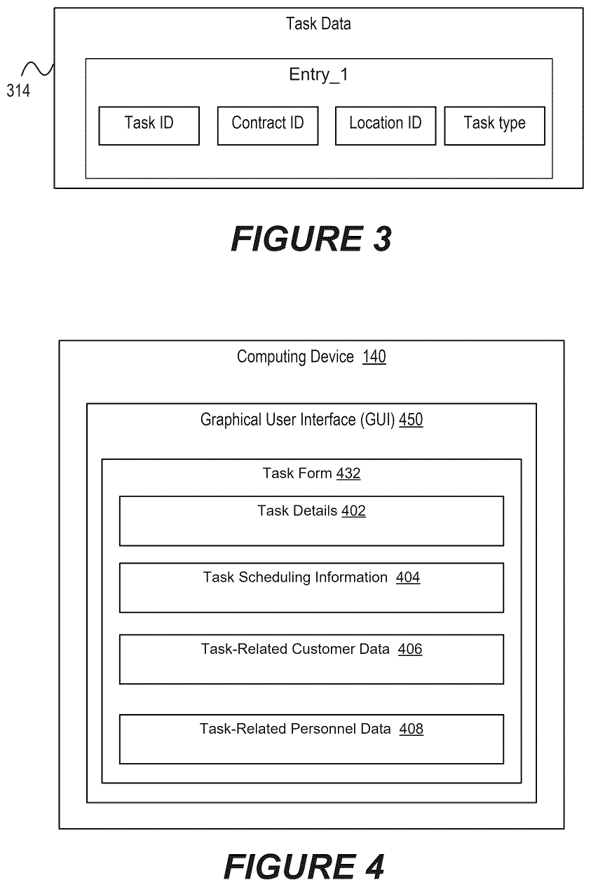

FIG. 3 is an example data structure configured to facilitate provision of a partitioned task management service according to one or more aspects. For example, the data structure may be associated with task data 314. Task data 314 may be stored in or associated with a look-up table in memory 106 of task management platform 102. Task data 314 may include one or more entries, such as a representative entry (Entry_1). The entry (Entry_1) may include one or more attributes or fields. In some implementation, each entry of the one or more entries includes the one or more attributes. As shown, the one or more attributes of the entry (Entry_1) include a task ID, a contract ID, a location ID, and a task type. Although the entry (Entry_1) is described as having four attributes, in other implementations, the entry (Entry_1) may have fewer than four attributes, more than four attributes, and/or different attributes than shown in FIG. 3. The task ID may include or indicate a unique identifier, such as a unique identifier of a task. The contract ID may include or indicate an identifier of a contract, such as a contract related to a vehicle that is associated with the task. The location ID may include or indicate a responsible party for the task, such as a dealership. The task type may include or indicate a type of the task, such as a task type category or a specific task type. For example, the task type may be a valet task or a maintenance task.

Additionally, or alternatively, the one or more attributes of the entry (Entry_1) may include a task subtype, a service type, a task status, a due date/time, a created date/time, a created by, an update date/time, an updated by, a started date/time, a finished date/time, a customer ID, a customer name, a vehicle ID, or a combination thereof. The task subtype may indicate a specific task type, such as if the task type indicates a task type category, or a subtask record. In some implementations, the subtask may include or point to an entry included subtask data 216.

The service type may indicate a type of service, such as a pickup service, a drop off service, an overnight service, a same day service, etc. The task status may indicate a status of the task, such as pending, started, finished, canceled, overdue, escalated, etc. In some implementations, a remedial action may be automatically initiated based on the task status. For example, a task status of overdue may initiate a notification to a supervisor responsible for the task. The due date/time may indicate a projected or scheduled due date/time of completion of the task. The created date/time may indicate a date/time that the task (e.g., the entry (Entry_1)) was created. The created by may indicate an individual that created or requested the task. The update date/time may indicate a date/time that any attribute of the entry (Entry_1) was last updated. The updated by may indicate an individual that updated an attribute of the entry (Entry_1). The started date/time may indicate a date/time that the task is started. The finished date/time may indicate a date/time that the task is completed. The customer ID may include or indicate a unique ID of a customer associated with the task. The customer name may indicate a name of the customer. The vehicle ID may indicate a unique identifier of the vehicle associated with the task.

In some implementations, one or more other data structure may be associated with task data 314 and/or stored in or associated with a look-up table in memory 106 of task management platform 102. For example, another data structure may be associated with subtask data, such as subtask data 216. The subtask data structure may include one or more attributes. For example, for a valet task, the subtask data structure may include an entry (or record) and the one or more attributes of the entry may include a subtask ID, a task ID, an address, a distance, an initial fuel amount, a final fuel amount, or a combination thereof. The subtask ID may include unique identifier of the subtask. The task ID may include or correspond to a corresponding task ID (e.g., of task data 314). The address may indicate a location where a loaner vehicle is to be deposited. The distance may include or indicate a distance from a present location of a loaner vehicle to an address to which the loaner vehicle is to be deposited. The initial fuel amount may indicate an amount of fuel in the loaner vehicle when the loaner vehicle is deposited at the indicated address. The final fuel amount may indicate an amount of fuel in the loaner vehicle when the loaner vehicle is returned.

As another example, another data structure may be associated with task related personal data, such as task related personnel data 220. To illustrate, the task related personal data data structure may include one or more attributes, such as an employee ID, a task ID, a location, an active, a created data/time, a created by, an updated date/time, an updated by, or a combination thereof. The employee ID may include or indicate an identifier associated with personnel assigned to perform a task. The task ID may include or correspond to a corresponding task ID (e.g., of task data 314). The location may indicate a location of personnel to perform the task. The active may include or indicate whether or not the task and/or subtask is open or closed. The created data/time indicate a date/time that the subtask was created. The created by may indicate an individual that created or requested the subtask. The updated date/time may indicate a date/time that any attribute of the subtask was last updated. The updated by may indicate an individual that updated an attribute of the subtask.

As another example, another data structure may be associated with historical data, such as historical data 224. To illustrate, the historical data data structure may include one or more attributes, such as an ID, a task ID, a previous status, an updated to status, an updated at, an updated by, or a combination thereof. The ID may include or indicate an identifier associated with a historical data entry that includes the one or more attributes. The task ID may include or correspond to a corresponding task ID (e.g., of task data 314). The previous status may indicate a previous status of a task, where the previous status is a status that is being transitioned from. The updated to status may indicate a status that is being transitioned to. The updated at may indicate a date/time (e.g., a timestamp that include a time, a date, or a combination thereof) that a status of a task was last updated. The updated by may indicate an individual that updated the status.

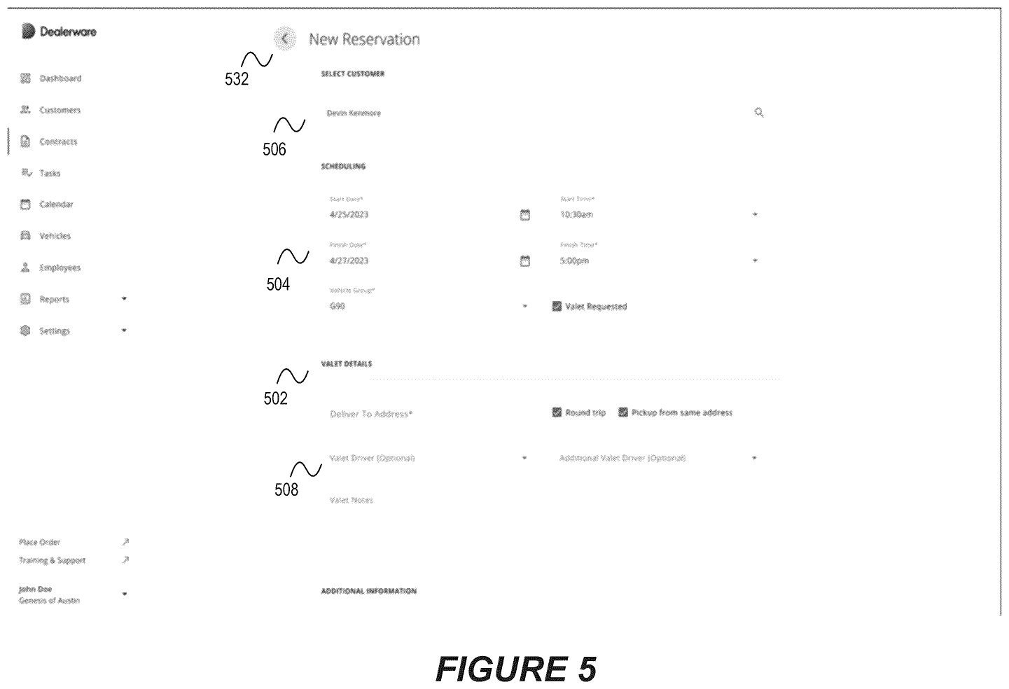

FIGS. 4 and 5 illustrate example task forms 432, 532 generated by a task management platform, such as by task management platform 102. As depicted in FIGS. 4 and 5, task form 432, 532 may be generated on a GUI, such as GUI 450, and rendered on a display of a computing device, such as computing device 140. Task form 432, 532 may include a plurality of fields to be completed by a user of a computing device, such as by a user of computing device 140, 154, or 156. These fields may include a task details 402, 502, task scheduling information 404, 504, task related customer data 406, 506, task related personnel data 408, 508, or any combination thereof. For example, task details 402, 502 may prompt a user of a computing device to include task details, such as the task type (e.g., a valet task) and, if a task is of a valet type, whether the task involved a round trip, pickup of a customer at an address, or combinations thereof. Task scheduling information 404, 504 may prompt a user to include a requested start date and start time of the task, a requested completion date and completion time of the task, or combinations thereof. Task related customer data 406, 506 may prompt a user of a computing device to indicate a customer identifier, such as a customer name. Task related personnel data 408, 508 may prompt a user of a computing device to enter a name of an employee selected to perform the task.

Other or different fields than those depicted in FIGS. 4 and 5 may be included in task forms 432, 532 depending on the task type indicated in a task request, such as task request 130. For example, in response to receipt of a task request, such as task request 130, corresponding to a maintenance task, a task management platform, such as task management platform 102 may generate a task form, such as task form 132, 432, 532, that requests identification of an item, such as a vehicle, on which the maintenance task is to be performed. Additionally, for a maintenance task related to a loaner vehicle, any customer-related fields may be omitted. Moreover, as explained with reference to FIG. 1, in some implementations, a task form, such as task form 132, 432, and 532 is not generated, since a task request may include task parameters, such as task parameters 134 sufficient for task management platform to populate a task record, such as task record 110.

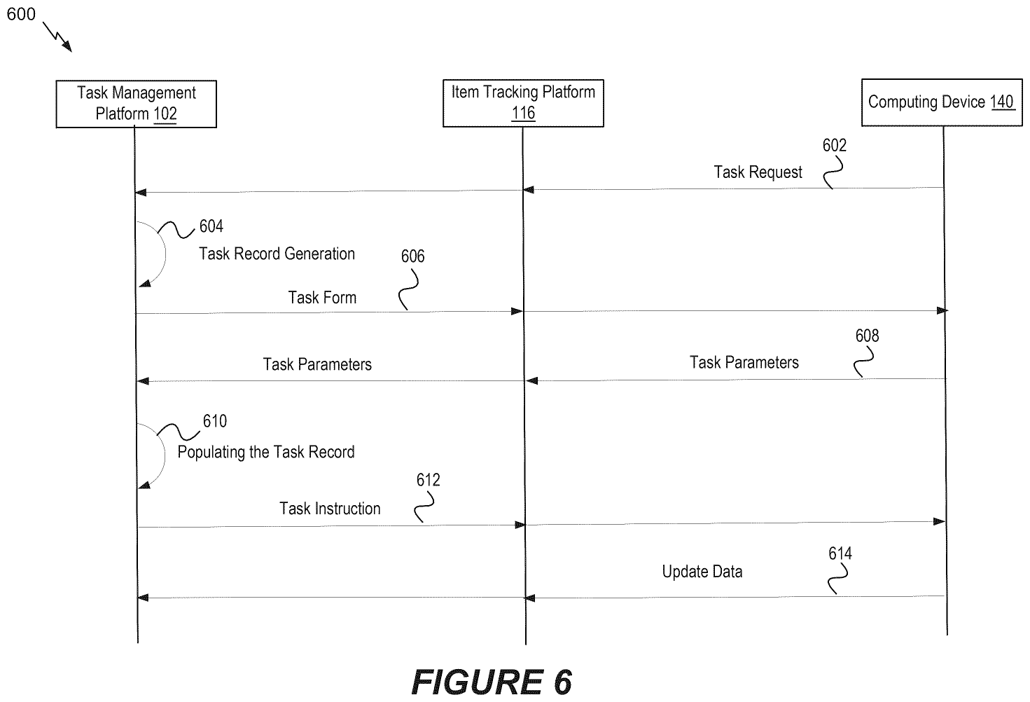

FIG. 6 is a ladder diagram depicting an example process 600 to facilitate provision of a partitioned task management service according to one or more aspects. At 602, task management platform receives a task request, such as task request 130. The task request may be generated at computing device 140 and sent, by computing device, to item tracking platform 116. Item tracking platform 116 may send the task request to task management platform 102. However, in some implementations, computing device 140 may send the task request to task management platform 102.

At 604, task management platform 102 generates a task record, such as task record 110. Task management platform 102 may generate the task record based on the task request. For example, task management platform 102 may parse the task request to identify a task associated with the task request. The task record may include a task ID corresponding to the identified task.

At 606, task management platform 102 generates a task form, such as task form 132, and sends the task form to item tracking platform 116. Task management platform 102 may generate the task form based on the task record. For instance, task management platform 102 may include fields in the task form that are tailored for or directed to the task associated with the task request. To illustrate, a task form for a valet task may include different fields than a task form generated for a maintenance task. Item tracking platform 116 may send the task form to computing device 140. However, in some implementations, task management platform 102 may send the task form directly to computing device 140.

At 608, task parameters, such as task parameters 134, are included in the task form. For example, a user of a computing device 140 may complete the fillable fields of the task form, including information in the task form corresponding to the task parameters. Alternatively, computing device 140 may be configured to autonomously complete the task form by including, in the task form, information requested by the fillable fields of the task form. For instance, computing device 140 may parse the fillable fields of the task form and, based on the parsing, may include responses in the fillable fields based on data stored in a memory of computing device 140. Computing device 140 may send the task parameters to item tracking platform 116, which may send the task parameters to task management platform 102. Alternatively, in some implementations, computing device 140 may send the task parameters directly to task management platform 102.

At 610, task management platform 102 may populate the task form. For instance, task management platform 102 may populate the task record, such as task record 110, based on the task parameters. Additionally or alternatively, task management platform may initiate a linking operation to link to a database, such as database 122, of item tracking platform 116 to extract data from the database that relates to the task request, the task parameters, or a combination thereof.

At 612, task management platform 102 may generate a task instruction, which task management platform may send to item tracking platform 116. Task management platform 102 may generate the task instruction based on the populated task record. Item tracking platform 116 may send the task instruction to computing device 140, at which the task instruction may be displayed. The task instruction may include scheduling information associated with the task, an identity of personnel to perform the task, a location at which the task is to be performed, or a combination thereof. In some implementations, the task instruction may be sent to a computing device associated with an employee or contractor who has been assigned the task as set forth in in the task instruction. While FIG. 6 shows that the task instruction is provided to a computing device, such as computing device 140, via item tracking platform 116, in some implementations, task management platform 102 send the task instruction directly to the computing device, such as directly to computing device 140.

At 614, task management platform 102 may receive update data. Update data may include or correspond to updates regarding a task status, such as reports indicating parts of a task that have been performed, an expected timeframe for task completion, or a combination thereof. In some implementations, update data may be generated at a computing device associated with personnel performing the task, which may include or correspond to computing device 140. For instance, as parts of a task are completed, an indicator may be generated and sent as part of the update data to indicate completion of the task component. Computing device 140 may send the update data to item tracking platform 116, which may send the update data to task management platform 102. Alternatively, in some implementations, computing device 140 may send the update data directly to task management platform 102.

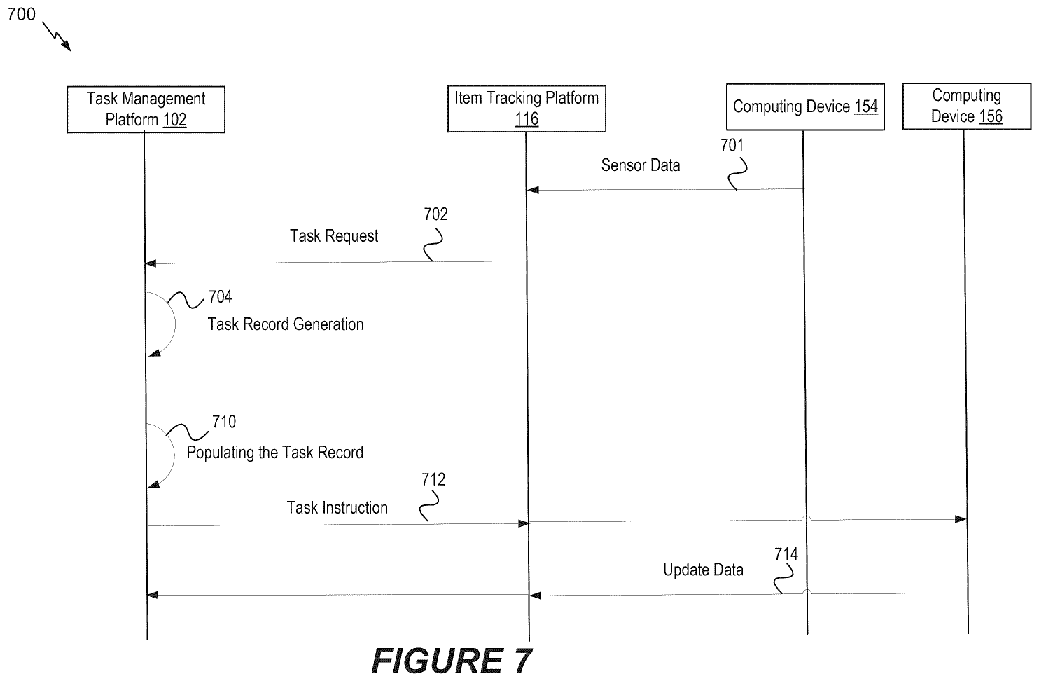

FIG. 7 is a ladder diagram depicting an example process 700 to facilitate provision of a partitioned task management service according to one or more aspects. At 701, computing device 154 sends sensor data 701 to item tracking platform 116. Computing device 154 may be a computing device positioned in vehicle that may receive sensor data from one or more sensors within the vehicle. Sensor data may include or correspond to an indication of a condition associated with the vehicle. For example, sensor data may indicate that oil of a vehicle is to be changed. At 702, in response to receipt of sensor data, tracking platform 116 may generate a task request, such as task request 130, based on the sensor data and may send the task request to task management platform 102. The task request may include the sensor data; an indication, based on the sensor data, of a maintenance task to be performed, such as a maintenance task associated with the vehicle in which computing device 154 is disposed; or any combination thereof. The task request may correspond to a maintenance task, such as a maintenance task associated with the vehicle in which computing device 154 is disposed.

At 704-710, task management platform 102 performs similar functionality to the functionality described with reference to 604-610 in FIG. 6. At 712, task management platform 102 generates and sends a task instruction, such as task instruction 136, to computing device 156. Computing device 156 may be associated with an employee or a contractor, identified in a task record populated at 710 and corresponding to task record 110, who is authorized and scheduled to perform the maintenance task specified in the task instruction. Alternatively, computing device 156 may be a robot configured to execute the task instruction. For example, the task instruction may be parsed by a machine, and computing device 156, receiving the task instruction, may be configured to execute the task instruction to perform the maintenance task.

At 714, a similar operation is performed as in 614 of FIG. 6. Alternatively, in an example in which computing device 156 is configured to execute the task instruction, computing device 156 also may be configured to generate update data, indicating sub-tasks or components of the maintenance task that have been completed, an expected completion date and time of the task, or a combination thereof.

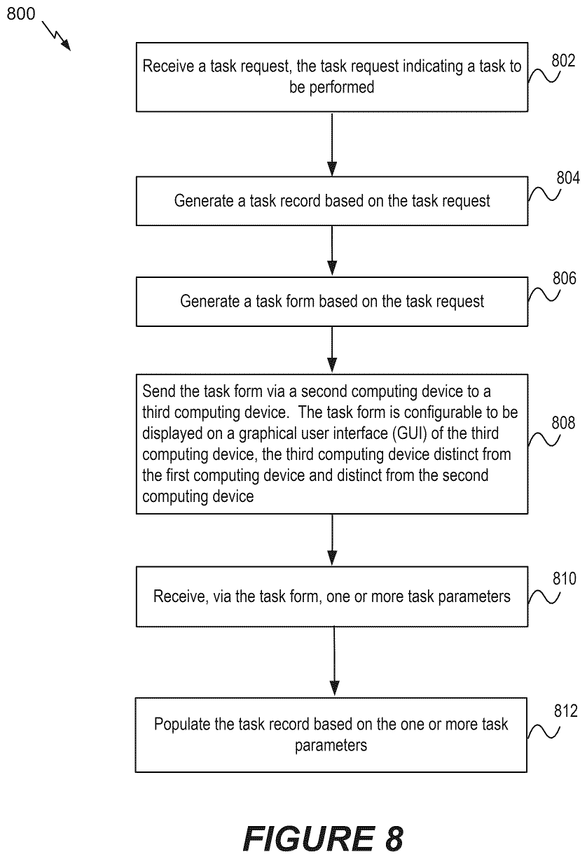

FIG. 8 is a flow diagram illustrating an example process 800 that supports a partitioned task management functionality according to one or more aspects. Operations of process 800 may be performed by a task management platform, such as task management platform 102 described above with reference to FIGS. 1-7.

At block 802, the task management platform receives a task request, the task request indicating a task to be performed. For example, task management platform 102 receives task request 130.

At block 804, the task management platform generates a task record based on the task request. For instance, task management platform 102 generates task record 110 based on task request 130.

At block 806, the task management platform generates a task form based on the task request. For example, task management platform 102 generates task form 132 based on task request 130.

At block 808, the task management platform sends the task form via a second computing device to a third computing device. The task form is configurable to be displayed on a GUI of the third computing device, the third computing device distinct from the first computing device and distinct from the second computing device. For example, task management platform 102 sends task form 132 via item tracking platform 116 to computing device 140, 154, or 156. Task form 132 is configurable to be displayed on I/O device 150 of computing device 140, 152, or 156, the I/O device 150 rendering a GUI that displays task form 132.

At block 810, the task management platform receives, via the task form, one or more task parameters. For instance, task management platform 102 receives, via task form 132, one or more task parameters 134.

At block 812, the task management platform populates the task record based on the one or more task parameters. For example, task management platform 102 populates task record 110 based on one or more task parameters 134.

In some implementations, the one or more task parameters include a task description corresponding to the task, object identification data corresponding to an object on which a task is to be performed, geolocation data indicative of a location at which the task is to be performed, a first value indicating a requested initiation timeframe to initiate performance of the task, a second value indicating a requested completion timeframe to complete performance of the task, or a combination thereof. For example, one or more of task parameters 134 may include or correspond to a task description corresponding to a task (e.g., associated with task request 130), object identification data corresponding to an object on which a task is to be performed, geolocation data indicative of a location at which the task is to be performed, a first value indicating a requested initiation timeframe to initiate performance of the task, a second value indicating a requested completion timeframe to complete performance of the task, or a combination thereof.

In some implementations, to populate the task record based on the one or more task parameters, the task management platform is configured to link to a first database stored in a first memory of the second computing device, the second computing device distinct from the first computing device and distinct from the third computing device. For example, task management platform 102 may populate task record 110 based on one or more of task parameters 134 by linking to database 122 stored in memory 120 of item tracking platform 116. Item tracking platform 116 may be distinct from task management platform 102 and may also be distinct from computing device 140, 154, 156. A linking operation may include or correspond to linking operation 210.

In some implementations, to populate the task record based on the one or more task parameters, the task management platform may, in response to linking to the first database, extract portions of data from the first database. The portions of data may be associated with the one or more task parameters, the task request, or a combination thereof. For example, to populate task record 110 based on one or more of task parameters 134 and in response to linking to database 122, task management platform 102 may be configured to extract portions of data from database 122. The extracted portions of data may be associated with one or more of task parameters 134, task request 130, or a combination thereof.

In some implementations, to populate the task record based on the one or more task parameters, the task management platform may additionally populate the task record based on the portions of data. For example, to populate task record 110 based on one or more of task parameter s 134, task management platform 102 may be configured to populate task record 110 based on portions of data extracted from database 122.

In some implementations, to implement a partitioned task management service, task management platform is further configured to store the task record in a second database, wherein the second database is partitioned from the first database. For example, to implement a partitioned task management service, task management platform 102 may be further configured to store task record 110 is task management database 110. Task management database 108 may be partitioned from database 122.

In some implementations, the portions of data include a plurality of data types associated with the task, the plurality of data types including task data indicating a unique task identifier associated with the task, subtask data indicating one or more subtasks associated with the task, customer data associated with a customer for whom the task is to be performed, personnel data associated with one or more persons who is to perform the task, task status data indicating a status of the task, or a combination thereof. For example, portions of data may include a plurality of data types associated with a task associated with or corresponding to task request 130. The plurality of data types may include task data 214 indicating a unique task identifier associated with the task (e.g., associated with task request 130), subtask data 216 indicating one or more subtasks associated with the task, task related customer data 218 associated with a customer for whom the task is to be performed, task related personnel data 220 associated with one or more persons who is to perform the task, task related historical data 224 indicating a status of the task, or a combination thereof.

In some implementations, the task record includes a unique task identifier associated with the task and a task type associated with the task. For example, task record 212 may include task ID 226 associated with a task associated with task request 130 and a task type associated with the task.

In some implementations, the task type includes one or more addresses in a second memory of the first computing device. For example, the task type may include one or more addresses in memory 106 of task management platform 102.

In some implementations, the one or more addresses store the subtask data corresponding to the task. For example, one or more addresses in memory 106 may be configured to store subtask data 216 corresponding to the task associated with task request 130.

In some implementations, the task form corresponds to a webpage. For example, task form 132, 432, 532 may include or correspond to a webpage. In some implementations, the webpage includes a plurality of entries. For example, task form 432, 532 includes a plurality of entries, such as task details 402,502; task scheduling information 404, 504; task-related customer data 406, 506; and task-related personnel data 408, 508.

In some implementations, the plurality of entries includes a task description entry, an object identification entry, a location entry, one or more scheduling entries, or a combination thereof. For instance, task details 402 may include or correspond to a task description entry, an object identification entry (e.g., indicating a vehicle on which a service is to be performed), a location entry (e.g., indicating a location of the vehicle), or a combination therefor. Additionally, task scheduling information 404 may include or correspond to one or more scheduling entries.

In some implementations, the task management platform is further configured to update the task record in response to receipt of task status data. For example, task management platform 102 may be configured to update task record 110 in response to receipt of task status data, such as may be stored in database 122. To illustrate, task management platform may perform linking operation 210 to obtain the task status data.

In some implementations, to update the task record, the task management platform is configured to link to a first database stored in a first memory of the second computing device. For example, task management platform 102 may be configured to link to database 122 stored in memory 120 of item tracking platform 116.

In some implementations, the second computing device is distinct from the first computing device and is distinct from the third computing device. For instance, item tracking platform 116 is distinct from task management platform and is distinct from computing device 140, 154, 156.

In some implementations, in response to linking to the first database, the task management platform is configured to extract task status data from the first database. For instance, in response to linking to database 122 (e.g., via linking operation 210), task management platform 102 may extract task status data from database 122.

In some implementations, the task status data is provided to the second computing device by the third computing device. For example, task status data may be provided to item tracking platform 116 by third computing device 140, 154, 156.

In some implementations, the task management platform is further configured to receive, from the second computing device, a second task request. For instance, task management platform 102 may be configured to receive, from item tracking platform 116, a second task request, such as may include or correspond to task request 130.

In some implementations, the second task request indicates a second task to be performed on an object based on data received at the second computing device from the object. For example, task request 130 (e.g., a second instance of task request 130) may indicate a second task to be performed on an object (e.g., a vehicle) based on data received at item tracking platform 116 from the object (e.g., the vehicle).

In some implementations, the second task request includes one or more second task parameters populated by the second computing device based on the data. For instance, the second task request may include one or more second task parameters populated by item tracking platform 116 based on the data.

In some implementations, the task management platform generates a second task record based on the second task request. For example, task management platform 102 may generate task record 110 (e.g., a second instance of task record 110) based on the task request 130 (e.g., the second instance of task request).

In some implementations, the task management platform populates the second task record based on the one or more second task parameters. For example, task management platform 102 populates task record 110 (e.g., a second instance of task record 110) based on one or more task parameters 134 (e.g., a second instance of task parameters 134).

In some implementations, the task management platform generates a second task form, the second task form populated based on the one or more second task parameters. For example, task management platform 102 generates task form 132 (e.g., a second instance of task form 132). The task form (e.g., the second instance of task form 132) may be populated based on one or more task parameters 134 (e.g., the second instance of task parameters 134).

In some implementations, the task management platform sends the second task form via the item tracking platform to one or more third computing devices. The task form is configurable to be displayed on a graphical user interface (GUI) of the third computing device. For example, task management platform 102 sends the second task form via item tracking platform 116 to computing device 140, 154, 156. The task for is configurable to be displayed on the GUI of one or more of computing devices 140, 154, 156.

In some implementations, the task management platform generates a task instruction based on the populated task record. For example, task management platform 102 generates task instruction 136 based on populated task record 110.

In some implementations, the task management platform sends the task instruction to the third computing device via the second computing device. For example, task management platform 102 sends task instruction 136 to computing device 140, 154, or 156 via item tracking platform 116.

In some implementations, in response to receipt of the task instruction by the third computing device, the third computing device is configured to update one or more fillable fields of the task form based on data included in the task instruction. For example, in response to receipt of task instruction 136 by third computing device 140, 154, or 156, third computing device 140, 154, 156 is configured to update one or more fillable fields of task form 132.

In some implementations, the task instruction includes data, commands, or a combination thereof. For example, task instruction 136 includes data, commands, or a combination thereof.

In some implementations, the third computing device, based on receipt of the task instruction, is configured to display the data on the GUI, perform one or more tasks in response to the command, or a combination thereof. For example, third computing device 140, 154, 156, based on receipt of task instruction 136, may be configured to display the data on the GUI, perform one or more tasks in response to the command, or a combination thereof.

In some implementations, the task management platform receives update data. The update data indicates a completion status of the task. For example, task management platform 102 receives update data 160. Update data 160 may indicate a completion status of the task.

In some implementations, the task management server updates the task record based on the update data. For example, task management server 102 updates task record 110 based on update data 160.

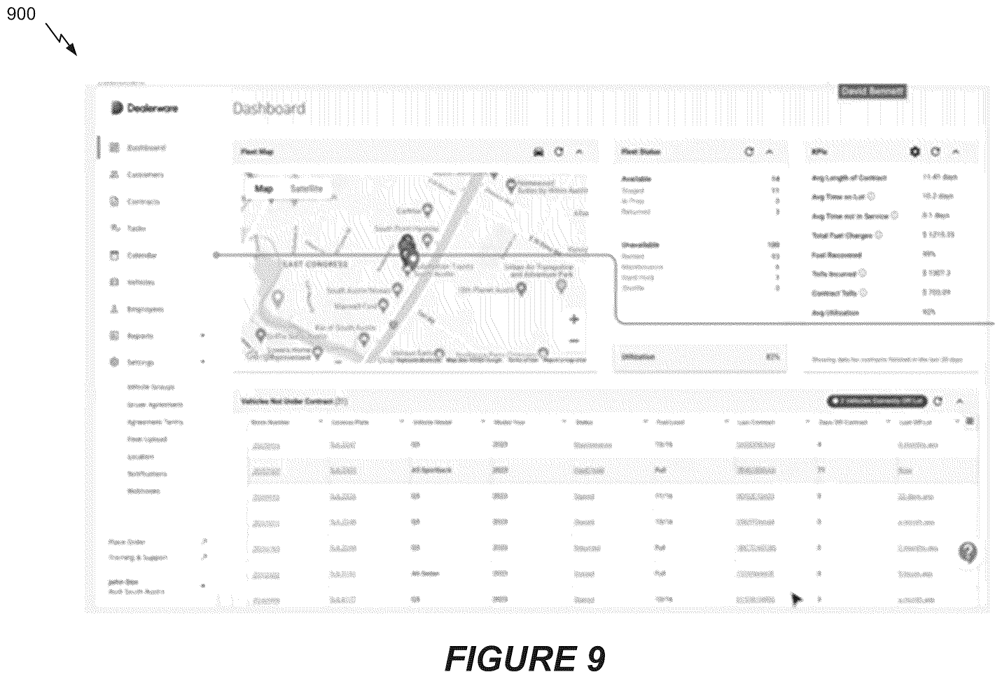

FIGS. 9-14 are screenshots depicting operations of a partitioned task management system according to one or more aspects. FIG. 9 depicts an example dashboard GUI 900 rendered on a display of a computing device, such as computing device 140, 154, or 156. Dashboard GUI 900 may correspond to a GUI through which a user of the computing device may initiate a task request, such as task request 130.

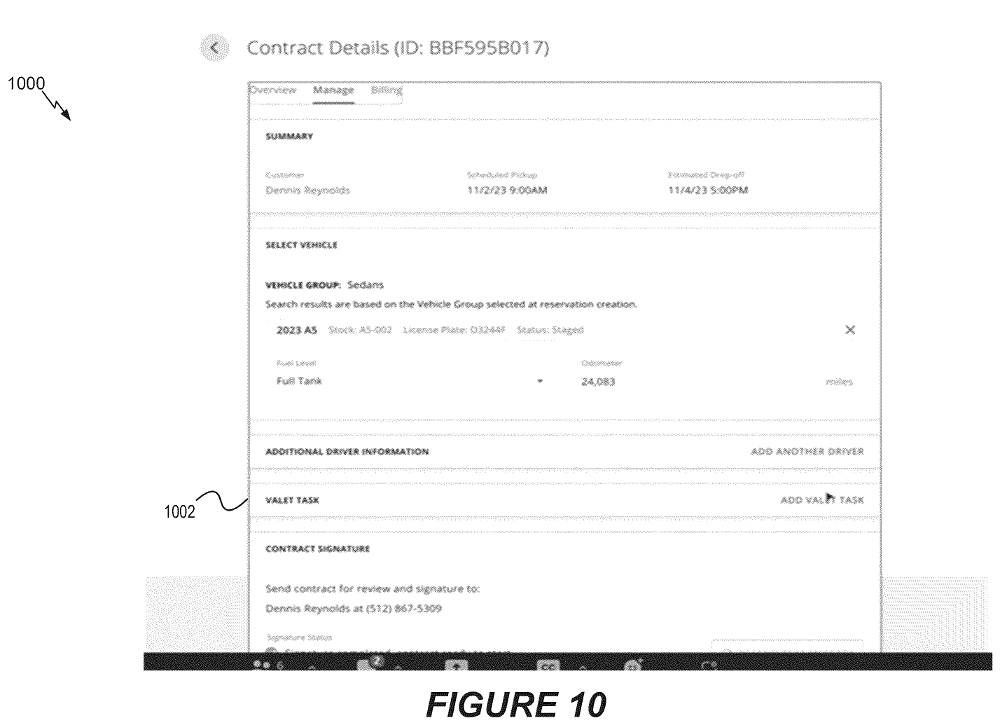

FIG. 10 depicts an example task request initiation GUI 1000 via a which a user of a computing device, such as a user of computing device 140, 154, or 156, initiates a task request, such as task request 130. For example, task request initiation GUI 1000 may include task initiation button 1002 via which a task request may be initiated. As depicted in FIG. 10, the task request is associated with a valet type task; however, other types of tasks may be requested in a similar manner. To elaborate, a task request initiation GUI, such as task request initiation GUI 1000, may include a drop down list via which a user may select different task types and whereby selection, by the user, of the task type initiates a task request.

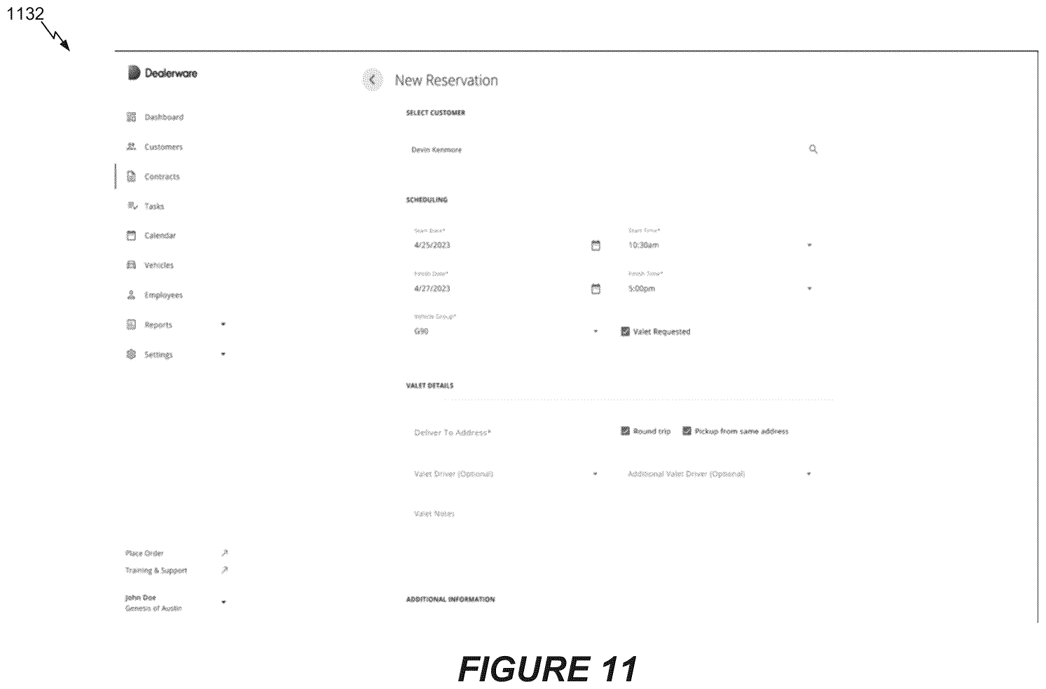

FIG. 11 depicts an example task form 1132, such as task form 132, configurable to be rendered on a GUI of computing device 140, 154, or 156. Task form 1132 corresponds to task form 532, described above with reference to FIG. 5. Referring to FIG. 12, in some implementations, one or more fields of the task form 1232, which corresponds to task form 132, 532, and 1132, are configurable to be updated based on the task instruction, such as task instruction 136. To illustrate, the task instruction, such as task instruction 136, may include information associated with an employee or contractor assigned to perform the task and in which the information included in the task instruction based on the task record, such as task record 110. In response to receipt of the task instruction, a computing device, such as computing device 140, 154, or 156, may execute the task instruction, updating one or more fields of the task form, such as task form 1232, rendered on a display of the computing device based on the task instruction. For instance, field 1202 of task form 1232 may be updated to include specific information about a valet task. Such information may include customer information, such as customer address 1204 at which a loaner vehicle is to be delivered, employee identifier 1206 identifying an employee of a dealership, such as first user entity 138, second user entity 152, to whom the valet task is assigned, and additional customer information, such as customer access codes 1208 to access customer address 1204 so that a loaner car may be delivered to the customer.

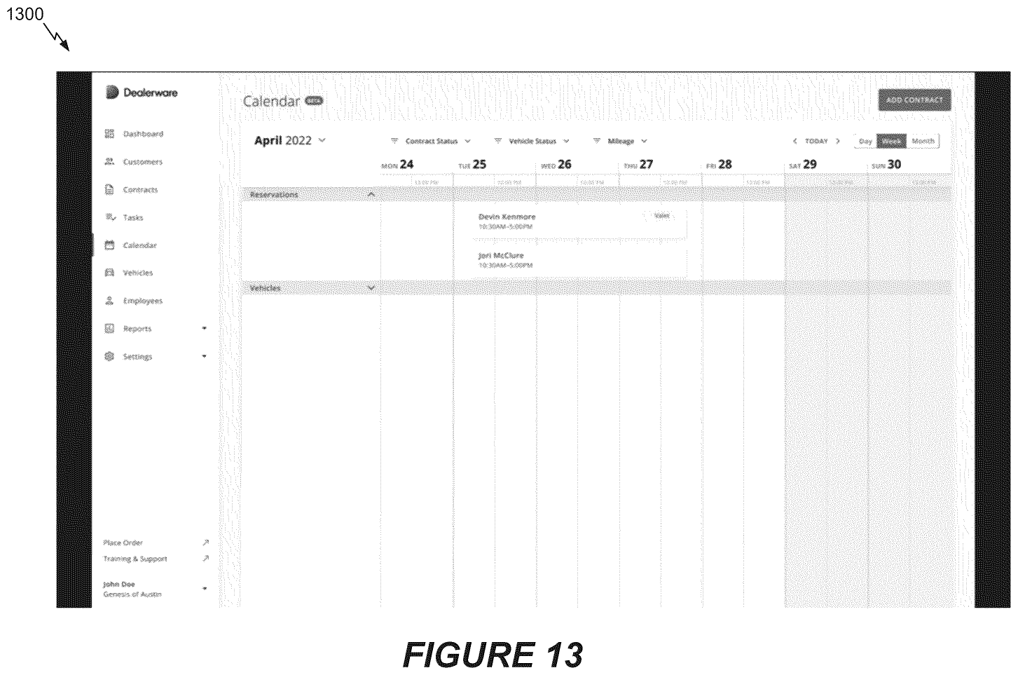

FIG. 13 depicts an example task schedule 1300, configurable to be rendered on a GUI of computing device 140, 154, or 156 based on a task instruction, such as task instruction 136 received at computing device 140, 154, or 156. In some implementations, the task instruction may include scheduling information to schedule a task, such as a valet task. As depicted in FIG. 13, task schedule 1300 may be included in a GUI rendered on a display of computing device 140, 154, or 156.

Certain features that are described in this specification in the context of separate implementations also can be implemented in combination in a single implementation. Conversely, various features that are described in the context of a single implementation also can be implemented in multiple implementations separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

Those of skill in the art would understand that information, message, and signals may be represented using any of a variety of different technologies and techniques. For example, data, instructions, commands, information, and signals that may be referenced throughout the above description may be represented by voltages, currents, electromagnetic waves, magnetic fields or particles, optical fields or particles, or any combination thereof.

Components, the functional blocks, and the modules described herein with the figures include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. The various illustrative logics, logical blocks, modules, circuits and algorithm processes described in connection with the implementations disclosed herein may be implemented as electronic hardware, computer software, or combinations of both. In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Additionally, the operations of a method or algorithm may reside as one or any combination or set of codes and instructions on a machine readable medium and computer-readable medium, which may be incorporated into a computer program product.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise.

The term “about” as used herein can allow for a degree of variability in a value or range, for example, within 10%, within 5%, or within 1% of a stated value or of a stated limit of a range, and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. Unless stated otherwise, the word or as used herein is an inclusive or and is interchangeable with “and/or,” such that when “or” is used in a list of two or more items, means that any one of the listed items can be employed by itself, or any combination of two or more of the listed items can be employed. To illustrate, A, B, or C includes: A alone, B alone, C alone, a combination of A and B, a combination of A and C, a combination of B and C, or a combination of A, B, and C. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”). As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any implementation of any of the systems, methods, and article of manufacture can consist of or consist essentially of—rather than comprise/have/include—any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The claims are not intended to include, and should not be interpreted to include, means-plus- or step-plus-function limitations, unless such a limitation is explicitly recited in a given claim using the phrase(s) “means for” or “step for,” respectively.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure and following claims are not intended to be limited to the examples and designs described herein but is to be accorded the widest scope consistent with the principles and novel features disclosed herein.

What is claimed is:

1. A method, performed by a first computing device, for implementing a partitioned task management service, the method comprising:
receiving a task request, the task request indicating a task to be performed;
generating a task record based on the task request;
generating a task form based on the task request;
sending the task form via a second computing device to a third computing device, wherein the task form is configurable to be displayed on a graphical user interface (GUI) of the third computing device, the third computing distinct from the first computing device and distinct from the second computing device;
receiving, via the task form, one or more task parameters; and
populating the task record based on the one or more task parameters.

2. The method of claim 1, wherein the one or more task parameters include a task description corresponding to the task, object identification data corresponding to an object on which a task is to be performed, geolocation data indicative of a location at which the task is to be performed, a first value indicating a requested initiation timeframe to initiate performance of the task, a second value indicating a requested completion timeframe to complete performance of the task, or a combination thereof.

3. The method of claim 1, wherein populating the task record based on the one or more task parameters includes:
linking to a first database stored in a first memory of the second computing device, the second computing device distinct from the first computing device and distinct from the third computing device;
in response to linking to the first database, extracting portions of data from the first database, the portions of data associated with the one or more task parameters, the task request, or a combination thereof; and
populating the task record based on the portions of data.

4. The method of claim 3, further comprising:
storing the task record in a second database, wherein the second database is partitioned from the first database.

5. The method of claim 3, wherein the portions of data include a plurality of data types associated with the task, the plurality of data types including task data indicating a unique task identifier associated with the task, subtask data indicating one or more subtasks associated with the task, customer data associated with a customer for whom the task is to be performed, personnel data associated with one or more persons who is to perform the task, task status data indicating a status of the task, or a combination thereof.

6. The method of claim 5, wherein the task record includes a unique task identifier associated with the task and a task type associated with the task, and wherein the task type includes one or more addresses in a second memory of the first computing device, the one or more addresses storing the subtask data corresponding to the task.

7. The method of claim 1, wherein the task form corresponds to a webpage, wherein the webpage includes a plurality of entries, and wherein the plurality of entries includes a task description entry, an object identification entry, a location entry, one or more scheduling entries, or a combination thereof.

8. The method of claim 1, further comprising updating the task record in response to receipt of task status data, wherein updating the task record comprises:
linking to a first database stored in a first memory of the second computing device, the second computing device distinct from the first computing device and distinct from the third computing device; and
in response to linking to the first database, extracting task status data from the first database, the task status data provided to the second computing device by the third computing device.

9. The method of claim 1, further comprising:
receiving, from the second computing device, a second task request, wherein the second task request indicates a second task to be performed on an object based on data received at the second computing device from the object, and wherein the second task request includes one or more second task parameters populated by the second computing device based on the data;
generating a second task record based on the second task request;
populating the second task record based on the one or more second task parameters;
generating a second task form, the second task form populated based on the one or more second task parameters; and
sending the second task form via the second computing device to the third computing device, wherein the task form is configurable to be displayed on the GUI of the third computing device.

10. The method of claim 1, further comprising:
generating a task instruction based on the populated task record; and
sending the task instruction to the third computing device via the second computing device.

11. The method of claim 10, wherein, in response to receipt of the task instruction by the third computing device, the third computing device is configured to update one or more fillable fields of the task form based on data included in the task instruction.

12. The method of claim 10, wherein the task instruction includes data, commands, or a combination thereof, and wherein the third computing device, based on receipt of the task instruction, is configured to display the data on the GUI, perform one or more tasks in response to the command, or a combination thereof.

13. The method of claim 1, further comprising:
receiving update data, the update data indicating a completion status of the task; and
updating the task record based on the update data.

14. An electronic device comprising:
at least one processor; and
a memory coupled with the at least one processor and storing processor-readable instructions that, when executed by the at least one processor, is configured to:
receive a task request, the task request indicating a task to be performed;
generate a task record based on the task request;
generate a task form based on the task request;
send the task form via a second computing device to a third computing device, wherein the task form is configurable to be displayed on a graphical user interface (GUI) of the third computing device, the third computing distinct from the first computing device and distinct from the second computing device;
receive, via the task form, one or more task parameters; and
populate the task record based on the one or more task parameters.

15. The electronic device of claim 14, where the processor-readable instructions, when executed by the at least one processor, is further configured to:
receive, from the second computing device, a second task request, wherein the second task request indicates a second task to be performed on an object based on data received at the second computing device from the object, and wherein the second task request includes one or more second task parameters populated by the second computing device based on the data;
generate a second task record based on the second task request;
populate the second task record based on the one or more second task parameters;
generate a second task form, the second task form populated based on the one or more second task parameters; and
send the second task form via the second computing device to the third computing device, wherein the task form is configurable to be displayed on the GUI of the third computing device.

16. The electronic device of claim 14, where the processor-readable instructions, when executed by the at least one processor, is further configured to:
generating a task instruction based on the populated task record; and
sending the task instruction to the third computing device via the second computing device, and
wherein the task instruction includes data, commands, or a combination thereof.

17. The electronic device of claim 14, where the processor-readable instructions, when executed by the at least one processor, is further configured to:
receive update data, the update data indicating a completion status of the task; and
update the task record based on the update data.

18. A non-transitory computer-readable medium storing instructions that, when executed by a processor, cause the processor to perform operations comprising:
receiving a task request, the task request indicating a task to be performed;
generating a task record based on the task request;
generating a task form based on the task request;
sending the task form via a second computing device to a third computing device, wherein the task form is configurable to be displayed on a graphical user interface (GUI) of the third computing device, the third computing distinct from the first computing device and distinct from the second computing device;
receiving, via the task form, one or more task parameters; and
populating the task record based on the one or more task parameters.

19. The non-transitory computer-readable medium of claim 18, where the operations to populate the task record based on the one or more task parameters include:
linking to a first database stored in a first memory of the second computing device, the second computing device distinct from the first computing device and distinct from the third computing device;
in response to linking to the first database, extracting portions of data from the first database, the portions of data associated with the one or more task parameters, the task request, or a combination thereof; and
populating the task record based on the portions of data.

20. The non-transitory computer-readable medium of claim 19, where the operations further include storing the task record in a second database, wherein the second database is partitioned from the first database.
